(19) United States
(12) Patent Application Publication
(10) Pub. No.: US 2026/0008427 A1
(43) Pub. Date: Jan. 8, 2026

(54) VEHICULAR INTERIOR COMPONENT

(71) Applicant: TOYOTA BOSHOKU KABUSHIKI KAISHA, Aichi-ken (JP)

(72) Inventors: Yuki MIZUNO, Aichi-ken (JP); Kyosuke II, Aichi-ken (JP)

(73) Assignee: TOYOTA BOSHOKU KABUSHIKI KAISHA, Aichi-ken (JP)

(21) Appl. No.: 19/245,901

(22) Filed: Jun. 23, 2025

(30) Foreign Application Priority Data
Jul. 5, 2024 (JP) 2024-108835

(51) Int. Cl. B60R 21/055; B60R 13/02

(52) U.S. Cl. CPC B60R 21/055; B60R 13/02; B60R 2013/0287

(57) ABSTRACT

A vehicular interior component covering a vehicular body from a vehicular interior side includes an interior component body and a functional component mounted on a vehicular exterior side of the interior component body. The interior component body includes a design surface section having a plate shape and configured as a portion of a vehicular interior design surface and a stopper projection that projects from the design surface section toward a vehicular exterior side and includes a weakened portion. The functional component includes a mount portion including a fitting hole in which the stopper projection is fitted.

### CROSS REFERENCE TO RELATED APPLICATION

This application claims priority from Japanese Patent Application No. 2024-108835 filed on Jul. 5, 2024. The entire contents of the priority application are incorporated herein by reference.

### TECHNICAL FIELD

The present technology described herein relates to a vehicular interior component.

### BACKGROUND

There has been known a vehicular interior component including a shock absorber for absorbing shock caused by a vehicle collision. The shock absorber is attached to a vehicular exterior side surface of a plate-shaped interior component body of the vehicular interior component. There has been known another vehicular interior component including a door trim, which is an interior component body, and a pocket board (a panel member) attached to the interior component body. In such a vehicular interior component, the pocket board is attached to the interior component body from a vehicular exterior side to close a door pocket opening of the interior component body and thus, a door pocket is formed. In such a vehicular interior component, a functional component is attached to the interior component body by fitting a projection that projects from a back surface of the interior component body into a fitting hole of the functional component.

### SUMMARY

In such a fitting structure of the projection and the fitting hole, if a large load is applied to the functional component from the vehicular exterior side due to a vehicle collision, a large force is applied to the projection and the interior component body may be damaged and broken. Particularly, a design surface portion of the interior component body that is configured as a design surface may be damaged. A peripheral edge of the fitting hole may include a recessed portion such that the projection is not broken. However, with the functional component being a shock absorber, the shock absorber may not be able to receive sufficient reaction force from the projection and may not exert effective shock absorbing properties. Therefore, the above-described fitting structure may be used for only particular kinds of functional components.

An object of the present technology described herein is to provide a vehicular interior component in which a design surface section of an interior component body is less likely to be damaged when a vehicle collision occurs.

A vehicular interior component according to the technology described herein covers a vehicular body from a vehicular interior side and the vehicular interior component includes an interior component body and a functional component. The interior component body includes a design surface section having a plate shape and configured as a portion of a vehicular interior design surface and a stopper projection projecting from the design surface section toward a vehicular exterior side and including a weakened portion. The functional component is mounted on a vehicular exterior side of the interior component body and includes a mount portion including a fitting hole in which the stopper projection is fitted.

### BRIEF DESCRIPTION OF THE DRAWINGS

FIG. 1 is an elevation view of a vehicular door trim.

FIG. 2 is a side view of the door trim seen from a vehicular exterior side.

FIG. 3 is an enlarged perspective view of a portion of a trim board including a shock absorber.

FIG. 4 is a cross-sectional view of the shock absorber along line iv-iv in FIG. 3.

FIG. 5 is an exploded perspective view of a fitting structure of the shock absorber and the trim board.

FIG. 6 is a perspective view of a stopper projection of a fitting structure that is different from that of the fitting structure of FIG. 5.

FIG. 7 is a cross-sectional view illustrating the fitting structure when a side collision occurs.

FIG. 8 is a cross-sectional view illustrating a fitting structure of a pocket board and the trim board along line viii-viii in FIG. 2.

### DETAILED DESCRIPTION

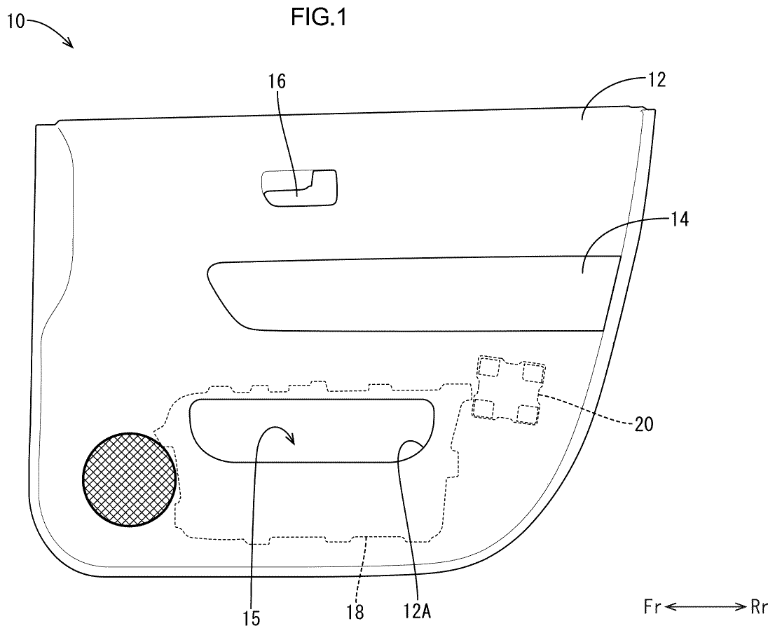

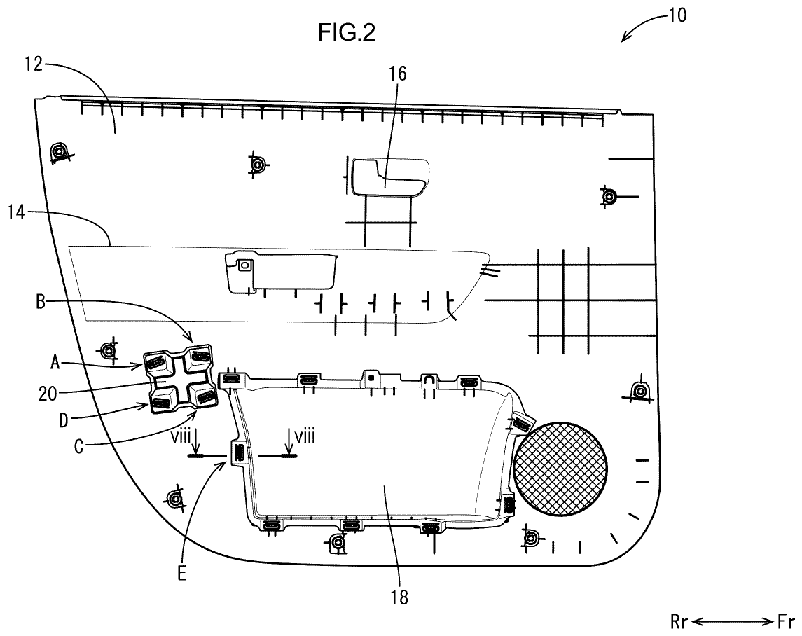

A vehicular door trim 10 according to one embodiment will be described. The door trim 10 is configured as a part of a vehicular side door. As illustrated in FIGS. 1 and 2, the door trim 10 includes a trim board 12, which is an interior component body, as a main component and is disposed to cover a door panel of the side door, which is a part of a vehicular body, from a vehicular interior side. An armrest 14, a door pocket 15, and an inside handle 16 are mounted on the trim board 12. The door pocket 15 is configured by mounting a pocket board 18 to cover a hole 12A in the trim board 12 from the vehicular exterior side. The pocket board 18 is one example of a functional component.

The door trim 10 of this embodiment includes a shock absorber 20, which is one example of the functional component. The shock absorber 20 is mounted on a vehicular exterior side of the trim board 12. The shock absorber 20 is disposed to be opposite a hip portion of an occupant who is seated on a vehicular seat, for instance. As illustrated in FIGS. 1 and 2, the shock absorber 20 is on a rear side of the pocket board 18 and below the armrest 14.

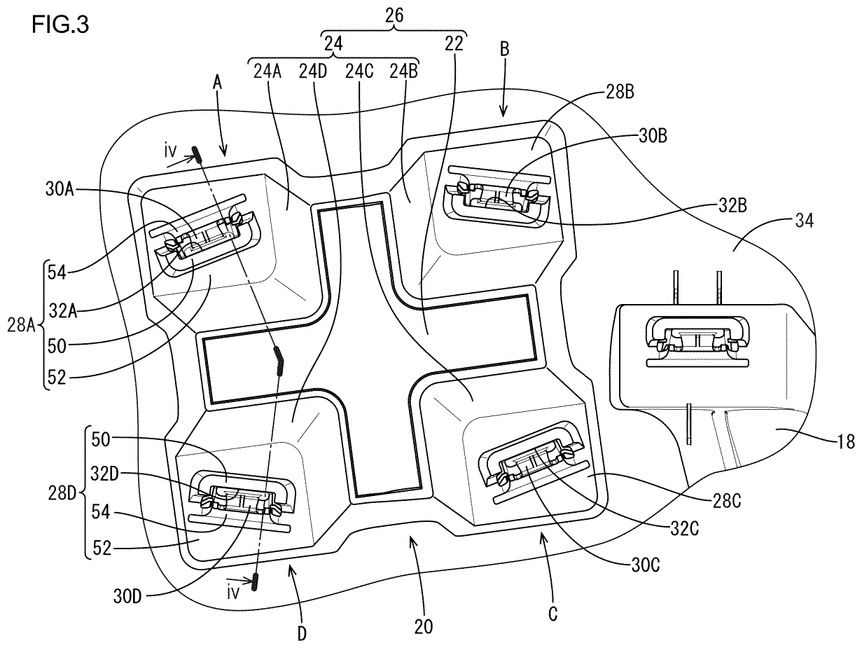

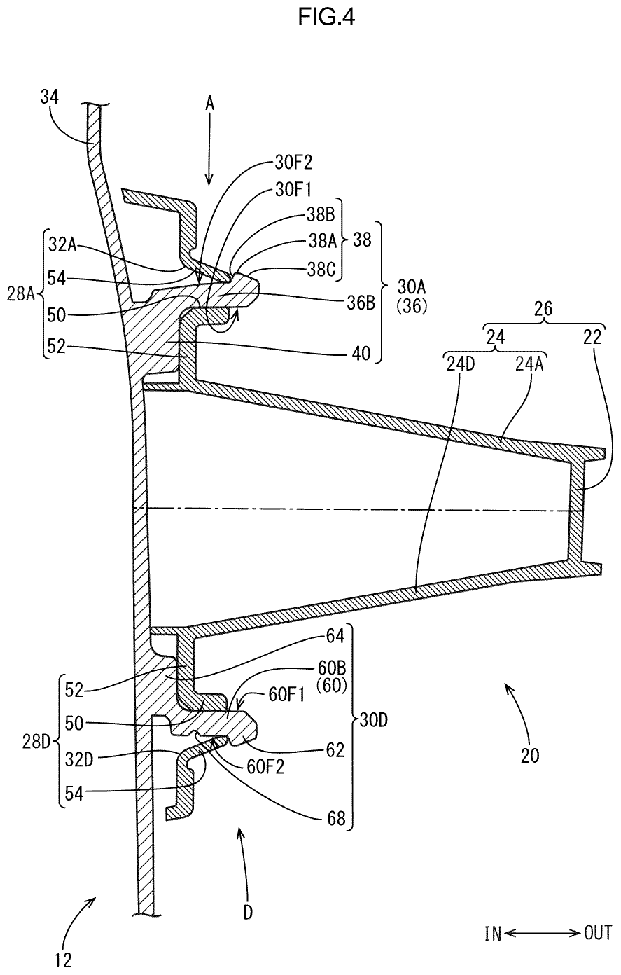

The shock absorber 20 is described with reference to FIGS. 3 to 5. The shock absorber 20 has a box shape opening toward the vehicular interior side. The shock absorber 20 includes a shock absorber body 26, which corresponds to a functional component body. The shock absorber body 26 is defined by an opposed wall 22 that is opposite the door panel and an outer wall 24 extending from an outer edge of the opposed wall 22 toward the vehicular interior side. The shock absorber body 26 has an inner space surrounded by the opposed wall 22 and the outer wall 24 and is a hollow member. The shock absorber 20 is made of synthetic resin (such as polypropylene) and produced with injection molding. The molding die used for producing the shock absorber 20 is opened and closed in a vehicular interior-exterior direction (a right-left direction in FIG. 4).

As illustrated in FIG. 3, the shock absorber 20 has a substantially square plan view shape seen from the vehicular exterior side. The shock absorber 20 includes the shock absorber body 26 in a center thereof and the shock absorber body 26 has a cross shape and projects toward the vehicular exterior side. The shock absorber 20 includes mount portions 28A, 28B, 28C, 28D at four corners, respectively, and the outer wall 24 of the shock absorber body 26 extends toward the vehicular exterior side from mount portions 28A, 28B, 28C, 28D. The shock absorber 20 includes the mount portions 28A, 28B, 28C, 28D near a peripheral edge of the shock absorber 20. The shock absorber 20 is mounted on the trim board 12 with the mount portions 28A, 28B, 28C, 28D. As illustrated in FIG. 3, the outer wall 24 of the shock absorber body 26 includes wall sections 24A, 24B, 24C, 24D each having a L-shaped cross section taken along a plate surface of the trim board 12. The mount portions 28A, 28B, 28C, 28D extends outward of the shock absorber body 26 from vehicular interior ends of the wall sections 24A, 24B, 24C, 24D, respectively.

As illustrated in FIG. 3, the mount portions 28A, 28B, 28C, 28D include fitting holes 32A, 32B, 32C, 32D, respectively, in which stopper projections 30A, 30B, 30C, 30D of the trim board 12 are fitted, respectively. A fitting structure of the mount portions 28A, 28B, 28C, 28D and the stopper projections 30A, 30B, 30C, 30D will be described with reference to FIGS. 4 to 7. The fitting structure includes four fitting structures A, B, C, D. The fitting structure A of the mount portion 28A and the stopper projection 30A will be described first.

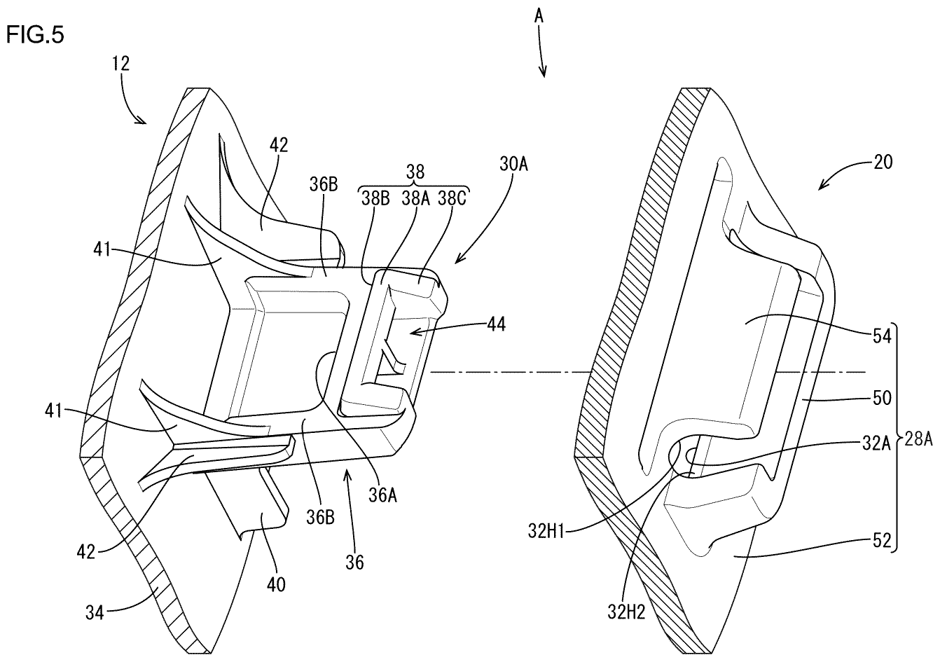

As illustrated in FIGS. 4 and 5, the stopper projection 30A projects toward the vehicular exterior side from a back surface of a design surface section 34 of the trim board 12. The design surface section 34 is configured as a vehicular interior design surface. The stopper projection 30A includes a stopper projection body 36 and a stopper portion 38. The stopper projection body 36 has a plate shape and projects from the design surface section 34 in a projecting direction. The stopper projection body 36 of the stopper projection 30A has a first surface 30F1 that is opposite the shock absorber body 26 and a second surface 30F2 that is opposite from the first surface 30F1. The stopper portion 38 is on the second surface 30F2 (an upper surface in FIGS. 4 and 5) of a distal end of the stopper projection body 36 and projects from the second surface 30F2. The stopper projection body 36 includes a thickness reduced portion 36A such that a sinkmark is less likely to be created on the design surface of the design surface section 34. Accordingly, the stopper projection body 36 includes thick portions 36B on two edge portions in a width direction that is perpendicular to the projecting direction in which the stopper projection body 36 projects. The thick portions 36B are thicker than a middle section of the stopper projection body 36. The stopper projection 30A includes a pair of first ribs 40, a pair of second ribs 41, and a pair of third ribs 42 to reinforce the stopper projection body 36. Specifically, the first ribs 40 extend from two edge portions (with respect to the width direction) of a first surface 30F1 of the stopper projection body 36 that is opposite from the second surface 30F2 having the stopper portion 38. The second ribs 41 extend from the thick portions 36B of the stopper projection body 36, respectively, toward the direction in which the stopper portion 38 projects. The third ribs 42 extend from the thick portions 36B, respectively, toward side directions.

As illustrated in FIGS. 4 and 5, the stopper portion 38 includes a ridge line 38A, a first slope surface 38B, and a second slope surface 38C. The ridge line 38A extends along the width direction of the stopper projection body 36. The first slope surface 38B extends from the ridge line 38A toward a basal end of the stopper projection body 36. The second slope surface 38C extends from the ridge line 38A toward the distal end of the stopper projection body 36. The stopper portion 38 and the stopper projection body 36 include a thickness reduced portion 44 on distal end side portions. The second slope surfaces 38C are on two edges of the stopper projection body 36 with respect to the width direction.

As illustrated in FIGS. 4 and 5, the mount portion 28A includes the fitting hole 32A, a support wall 50 (a second wall), a plate base 52, and a deformable wall 54 (a first wall). The fitting hole 32A is an elongated hole in which the stopper projection 30A is inserted. As illustrated in FIG. 5, the fitting hole 32A has two long hole edges including a first hole edge 32H1 and a second hole edge 32H2. The first hole edge 32H1 is closer to the shock absorber body 26 than the fitting hole 32A is. The second hole edge 32H2 is on an opposite side from the shock absorber body 26 with respect to the fitting hole 32A. The second hole edge 32H2 is farther away from the shock absorber body 26 than the first hole edge 32H1 is. The first hole edge 32H1 and the second hole edge 32H2 are opposed to each other.

The support wall 50 projects from the plate base 52 toward the vehicular exterior side. The support wall 50 projects from the second hole edge 32H2 of the fitting hole 32A. The support wall 50 has a plan view U-shape so as to cover a half of the fitting hole 32A. The support wall 50 extends along the second hole edge 32H2 of the fitting hole 32A and along a portion of each of two ends of the fitting hole 32A with respect to the width direction (short hole edges). The support wall 50 projects vertically from the plate base 52 toward the vehicular exterior side.

The deformable wall 54 projects from the plate base 52 toward the vehicular exterior side. The deformable wall 54 projects from the first hole edge 32H1 of the fitting hole 32A. The deformable wall 54 is on an opposite side from the support wall 50 with respect to the fitting hole 32A and is opposed to the support wall 50. The deformable wall 54 extends toward the vehicular exterior side with being inclined toward the support wall 50. The deformable wall 54 is not connected to the support wall 50. Two edges of the deformable wall 54 with respect to the width direction are away from two edges of the support wall 50, respectively. The deformable wall 54 is a plate member and elastically deformable such that a distal end portion moves with a basal end portion (the hole edge 32H2 of the fitting hole 32A) being as a fixed point. Namely, the deformable wall 54 is movable such that a distance between the distal end portion of the deformable wall 54 and the support wall 50 changes.

With the stopper projection 30A being inserted in the fitting hole 32A, the stopper portion 38 of the stopper projection 30A (the second slope surface 38C) comes in contact with the deformable wall 54. The first surface 30F1 of the stopper projection body 36 that is opposite from the stopper portion 38 is contacted with and supported by the support wall 50. Therefore, the stopper projection 30A is inserted in the fitting hole 32A with the deformable wall 54 being elastically deformed so as to increase the distance between the deformable wall 54 and the support wall 50. Then, when the stopper portion 38 passes through the fitting hole 32A, the deformable wall 54 restores its original shape and comes in contact with the first slope surface 38B of the stopper portion 38 and the second surface 30F2 of the stopper projection body 36. Thus, the stopper projection 30A is fitted in the fitting hole 32A (fitted state). In the fitted state, the first ribs 40 are in contact with the plate base 52 of the mount portion 28A and the stopper projection 30A holds the mount portion 28A between the stopper portion 38 and the first ribs 40. In the fitted state, the mount portion 28A holds the stopper projection body 36 of the stopper projection 30A between the support wall 50 and the deformable wall 54 and the mount portion 28A and the stopper projection 30A are fitted together firmly. Therefore, the shock absorber 20 is fixed to the trim board 12 firmly. In the fitted state, the first surface 30F1, 60F1 of the stopper projection body 36, 60 is contacted with the support wall 50 and the second surface 30F2, 60F2 of the stopper projection body 36, 60 is away from the first hole edge 32H1.

The mount portion 28B and the stopper projection 30B are fitted together with the fitting structure B and the mount portion 28C and the stopper projection 30C are fitted together with the fitting structure C. The fitting structure B and the fitting structure C are same as the fitting structure A of the mount portion 28A and the stopper projection 30A. The fitting structure D with which the mount portion 28D and the stopper projection 30D are fitted together differs from the fitting structures A, B, and C. Specifically, the mount portion 28D is same as the mount portion 28A; however, the stopper projection 30D differs from the stopper projection 30A.

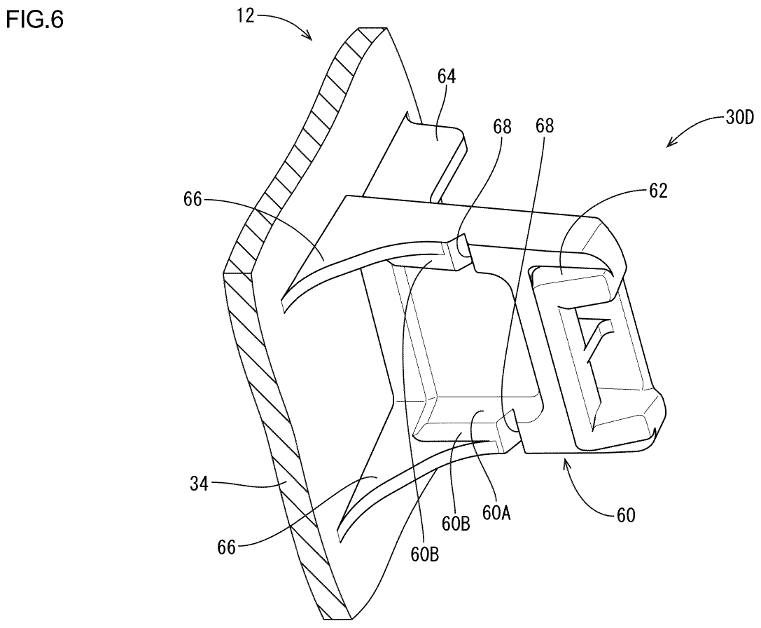

As illustrated in FIG. 6, the stopper projection 30D includes a stopper projection body 60 and a stopper portion 62 similar to the stopper projection 30A. The stopper projection body 60 has a plate shape and projects from the design surface section 34 in a projecting direction. The stopper projection body 60 of the stopper projection 30D has a first surface 60F1 that is opposite the shock absorber body 26 and a second surface 60F2 that is opposite from the first surface 60F1. The stopper portion 62 is on the second surface 60F2 of a distal end of the stopper projection body 60 and projects from the second surface 60F2. The stopper projection body 60 includes a thickness reduced portion 60A. Accordingly, the stopper projection body 60 includes thick portions 60B on two edge portions in a width direction that is perpendicular to the projecting direction in which the stopper projection body 60 projects. The thick portions 60B are thicker than a middle section. The stopper projection 30D includes a pair of first ribs 64 and a pair of second ribs 66 to reinforce the stopper projection body 60. The stopper projection 30D does not include third ribs. The first ribs 64 extend from two edge portions (with respect to the width direction) of the first surface 60F1 of the stopper projection body 60 that is opposite from the second surface 60F2 having the stopper portion 62. The second ribs 66 extend from the thick portions 60B of the stopper projection body 60, respectively, toward the direction in which the stopper portion 62 projects. According to such a configuration, rigidity of the stopper projection 30D is lower than that of the stopper projections 30A, 30B, 30C.

The stopper projection 30D includes recessed portions 68 (a weakened portion) in the thick portions 60B on the two edge portions of the stopper projection body 60, respectively. The recessed portion 68 is on the second surface 60F2 side of the thick portion 60B having the stopper portion 62 and is a V-shaped recess. The recessed portion 68 is recessed to be away from the peripheral edge of the shock absorber 20. As illustrated in FIG. 4, the recessed portion 68 is closer to the basal end of the stopper projection body 60 than the stopper portion 62 is and closer to the distal end of the stopper projection body 60 than the first rib 64 and the second rib 66 are. The recessed portion 68 is between the basal end of the stopper projection body 60 and the stopper portion 62. The recessed portion 68 is between the second rib 66 and the distal end of the stopper projection body 60.

As illustrated in FIG. 3, two of the four fitting structures A, B, C, and D that are arranged in the upper-bottom direction (the fitting structures A and D, the fitting structures B and C) are not arranged to extend parallel to each other, and two of the four fitting structures A, B, C, and D that are arranged in the front-rear direction (the fitting structures A and B, the fitting structures C and D) are not arranged to extend along one straight line. Specifically, the support walls 50 of the mount portions 28A, 28B, 28C, 28D are arranged such that surfaces of the support walls 50 face toward a center of the shock absorber 20. The support walls 50 are slightly inclined with respect to the front-rear direction. Namely, the mount portions 28A, 28B, 28C, 28D are arranged such that the deformable walls 54 are on an outer side of the support walls 50 with respect to the shock absorber body 26.

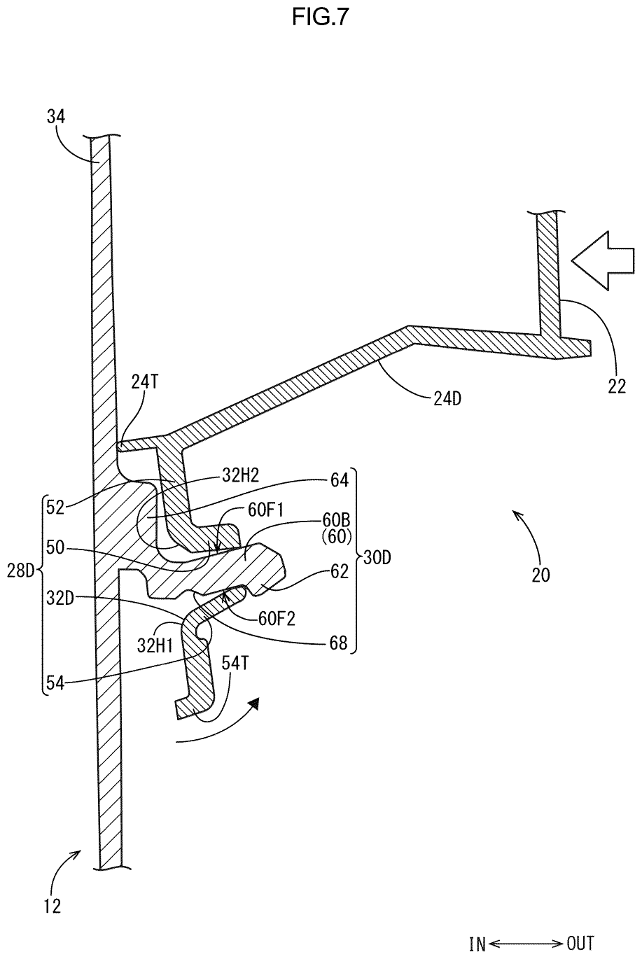

Next, operations of the shock absorber 20 when a side collision occurs on a side surface of a vehicle including the door trim 10 of this embodiment will be described. When a side collision occurs, the door panel hits the opposed wall 22 of the shock absorber 20 and the opposed wall 22 is pushed toward the vehicular interior side. Then, as illustrated in FIG. 7, the outer wall 24 is bucked to be bent inward and shock caused by the side collision is absorbed by the buckling.

As previously described, the mount portions 28A, 28B, 28C, 28D and the stopper projections 30A, 30B, 30C, 30D of the shock absorber 20 are fitted together firmly. Therefore, in case of the side collision, the stopper projections 30A, 30B, 30C, 30D are not released and reaction force with respect to the shock caused by the side collision is effectively created. On the other hand, a large load is applied to the design surface section 34 from the mount portions 28A, 28B, 28C, 28D of the shock absorber 20 via the stopper projections 30A, 30B, 30C, 30D. If the load applied to the design surface section 34 is too large, the design surface section 34 may be damaged.

In the door trim 10 of this embodiment, with the outer wall 24 being bent inward with buckling as illustrated in FIG. 7, the mount portions 28A, 28B, 28C, 28D extending outward from the outer wall 24 receive a force to be pivotably moved. With receiving such a force, the mount portions 28A, 28B, 28C, 28D are deformed such that edge portions 54T of the mount portions 28A, 28B, 28C, 28D move toward the vehicular exterior side with a distal end 24T of the outer wall 24 (a contact portion where the distal end 24T of the outer wall 24 is contacted with a back surface of the design surface section 34) being as a basal point. The mount portions 28A, 28B, 28C, 28D receive a force to be pivotally moved toward the vehicular exterior side with the vehicular interior end of the outer wall 24 being as a basal point. Such a force of the pivotal movement is applied to the stopper portions 38, 62 of the stopper projections 30A, 30B, 30C, 30D via the deformable walls 54 and a large load is further applied to the design surface section 34 via the stopper projection bodies 36, 60 and the first ribs 40, 64.

In the door trim 10 of this embodiment, it is confirmed that the fitting structure D, which is a lower rear one of the four fitting structures A, B, C, D, receives a largest load when a side collision occurs. The fitting structure D, which is a lower rear one, includes the recessed portions 68 in the stopper projection 30D as previously described. With such a configuration, as illustrated in FIG. 7, if a large force acts on the stopper portion 62 of the stopper projection 30D, the stopper projection body 60 of the stopper projection 30D is bent at the recessed portions 68 (the weakened portion). Therefore, a large load is less likely to be transferred from the stopper projection 30D to the design surface section 34 and the design surface section 34 is less likely to be damaged or broken.

In this embodiment, even if the stopper projection 30D is damaged or broken, the shock absorber 20 is fixed to the trim board 12 with the stopper projections 30A, 30B. 30C. Therefore, a reaction force with respect to the collision is effectively created and shock caused by the side collision can be effectively absorbed.

In the door trim 10 of this embodiment, the pocket board 18, which is a functional component, includes the fitting structure A (B, C) and the fitting structure D. The pocket board 18 includes mount portions 70 that have a configuration same as the configuration of the mount portion 28A (28B, 28C, 28D). The trim board 12 includes stopper projections around the hole 12A and the stopper projections have a configuration same as that of the stopper projection 30A (30B, 30C) or the stopper projection 30D. The pocket board 18 is fixed to the trim board 12 by fitting the mount portions 70 to the stopper projections.

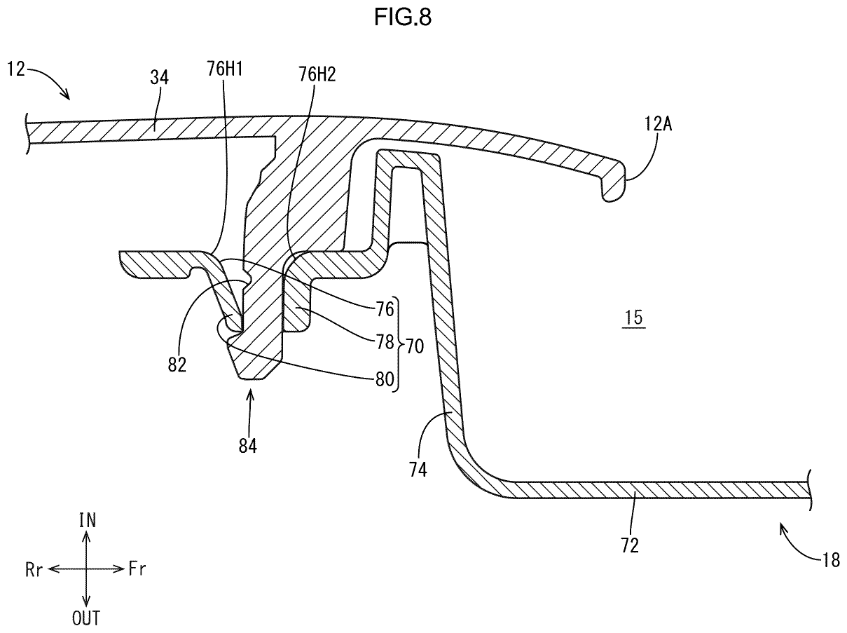

In this embodiment, the fitting structures of the pocket board 18 and the trim board 12 include a fitting structure E that is same as the fitting structure D. As illustrated in FIG. 8, the pocket board 18 includes an inner wall 72 (corresponds to the opposed wall opposite the door panel), a side wall 74 (corresponds to the outer wall), and a mount portion 70. The inner wall 72 and the side wall 74 are away from the design surface section 34 of the trim board 12 and on the vehicular exterior side. The inner wall 72 is configured as an inner wall of the door pocket 15. The side wall 74 extends from an edge (a rear edge) of the inner wall 72 toward the vehicular interior side. The mount portion 70 extends outward (rearward) from a vehicular interior side portion of the side wall 74. The mount portion 70 includes a fitting hole 76, a support wall 78, and a deformable wall 80. The fitting hole 76 is an elongated hole extending in the upper-bottom direction. The support wall 78 extends from a second hole edge 76H2 of the fitting hole 76 that is close to the side wall 74. The deformable wall 80 extends from a first hole edge 76H1 of the fitting hole 76 that is opposite from the side wall 74. The first hole edge 76H1 and the second hole edge 76H2 are opposite each other. The trim board 12 includes a stopper projection 84 similar to the stopper projection 30D. The stopper projection 84 includes recessed portions 82 (the weakened portion). The stopper projection 84 is fitted to the mount portion 70.

In the pocket board 18, similar to the shock absorber 20, a large force caused by the side collision may act on the inner wall 72 and the side wall 74 may be deformed with buckling. By the deformation of the side wall 74 with buckling, a large load may be applied to the design surface section 34 from the mount portion 70 via the stopper projection 84. The stopper projection 84 is bent at the recessed portions 82 and the design surface section 34 is less likely to be damaged or broken.

### Other Embodiments

The technology described herein is not limited to the embodiments described above with reference to the drawings. The following embodiments may be included in the technical scope. The technology described herein may be modified within the technical scope.

In the above embodiment, among the four fitting structures A, B, C, D for joining the shock absorber 20 and the trim board 12, only the fitting structure that is mounted on a portion where a large load is to be applied includes the recessed portion (the weakened portion) in the stopper projection. One or more of the fitting structures A, B, C may include the recessed portion (the weakened portion) in the stopper projection. In such a configuration, the recessed portions of each of the fitting structures may be configured to be damaged or broken by different loads.

In the above embodiment, the shock absorber body 26 of the shock absorber 20 has a cross shape but may have any other shapes.

In the above embodiment, the thick portions 60B are formed with the stopper projection body 36 including the thickness reduced portion 36A and the recessed portions 68 (the weakened portion) are in the thick portions 60B on the two edge portions of the stopper projection body 60 with respect to the width direction. A thickness reduced portion may not be formed and the stopper projection body may have a constant thickness. In such a configuration, the stopper projection body may include a groove extending along the width direction or include a thin portion or multiple holes arranged along the width direction as the weakened portion.

In the above embodiment, the mount portion includes the deformable wall and the support wall (a support portion) that project from the hole edge of the fitting hole toward the vehicular exterior side. The mount portion may be a fitting hole that is through the plate base 52.

The vehicular interior component of the above embodiments may not be necessarily included in an automobile but may be included in various kinds of vehicles. Examples of the vehicles may be vehicles running on the ground such as a train and an amusement vehicle, flying vehicles such as an airplane and a helicopter, and vehicles on the sea such as a ship.

1. A vehicular interior component covering a vehicular body from a vehicular interior side, the vehicular interior component comprising:
an interior component body including
a design surface section having a plate shape and configured as a portion of a vehicular interior design surface, and
a stopper projection projecting from the design surface section toward a vehicular exterior side and including a weakened portion; and
a functional component mounted on a vehicular exterior side of the interior component body and including a mount portion including a fitting hole in which the stopper projection is fitted.

2. The vehicular interior component according to claim 1, wherein
the functional component includes a functional component body that includes
an opposed wall that is opposite the vehicular body, and
an outer wall extending from an outer edge of the opposed wall toward the interior component body, the outer wall and the opposed wall defining an inner space in the functional component body,
the mount portion extends outward from the outer wall of the functional component body,
the stopper projection has a first surface that is opposite the functional component body and a second surface that is opposite from the first surface, and
the weakened portion is a recessed portion that is on the second surface of the stopper projection.

3. The vehicular interior component according to claim 2, wherein
the stopper projection includes a stopper projection body that extends from the interior component body and a stopper portion that projects from the second surface of a distal end of the stopper projection body,
the stopper portion is stopped by a first hole edge of the fitting hole that is on an opposite side from the functional component body with respect to the fitting hole, and
the recessed portion is between a basal end of the stopper projection body and the stopper portion.

4. The vehicular interior component according to claim 3, wherein
the stopper projection includes a rib that connects the second surface of the stopper projection body and a vehicular exterior side surface of the interior component body, and
the recessed portion is between the rib and the distal end of the stopper projection body.

5. The vehicular interior component according to claim 3, wherein
the mount portion includes
a first wall extending from the first hole edge of the fitting hole toward the vehicular exterior side and the functional component body, and
a second wall extending toward the vehicular exterior side from a second hole edge of the fitting hole, the second hole edge being closer to the functional component body than the fitting hole is, the second wall supporting the stopper projection body, and
the first wall and the second wall hold the stopper projection body of the stopper projection between the first wall and the second wall and the stopper portion of the stopper projection is contacted with and stopped by a distal end of the first wall.

6. The vehicular interior component according to claim 1, wherein
the functional component is a shock absorber,
the stopper projection of the interior component body includes multiple stopper projections, and
one of the multiple stopper projections that is to receive a largest load includes the weakened portion.

7. The vehicular interior component according to claim 1, wherein
the functional component has a peripheral edge and includes the mount portion adjacent to the peripheral edge, and
the weakened portion is a recessed portion that is recessed to be away from the peripheral edge.

8. The vehicular interior component according to claim 7, wherein the stopper projection is deformable to be bent at the recessed portion when receiving a load.

9. The vehicular interior component according to claim 7, wherein
the functional component includes a functional component body,
the mount portion extends outward from the functional component body, and
the stopper projection has a first surface that is opposite the functional component body and a second surface that is opposite from the first surface and includes the recessed portion on the second surface.

10. The vehicular interior component according to claim 9, wherein
the mount portion includes
a first wall extending toward the vehicular exterior side and the functional component body from a first hole edge of the fitting hole that is on an opposite side from the functional component body with respect to the fitting hole, and
a second wall extending toward the vehicular exterior side from a second hole edge of the fitting hole that is closer to the functional component body than the fitting hole is, and
the first surface of the stopper projection is contacted with the second wall and the second surface of the stopper projection is away from the first hole edge.
